(19) United States
(12) Patent Application Publication
(10) Pub. No.: US 2023/0207852 A1
(43) Pub. Date: Jun. 29, 2023

(54) BINARY REDOX FLOW BATTERY FOR SIMULTANEOUSLY CHARGING AND DISCHARGING ELECTRICITY

(71) Applicant: Energao, Inc., Makanda, IL (US)

(72) Inventor: Rong Jiang, Makanda, IL (US)

(21) Appl. No.: 18/088,262

(22) Filed: Dec. 23, 2022

Related U.S. Application Data
(60) Provisional application No. 63/293,885, filed on Dec. 27, 2021.

(51) Int. Cl. H01M 8/18; H01M 4/96

(52) U.S. Cl. CPC H01M 8/188; H01M 4/96; H01M 2004/8694

(57) ABSTRACT

Provided in this patent disclosure are a novel titanium redox flow battery having a nitrogen-enriched catalyst, and a binary redox flow battery comprised of one unit that converts electricity into chemical energy to be stored in electrolytes and a separate second unit that converts the chemical energy from electrolytes back into electricity.

### CROSS-REFERENCE TO RELATED APPLICATIONS

This application claims benefit of U.S. Provisional Patent Application 63/293,885, which was filed in the U.S. Patent and Trademark Office on Dec. 27, 2021, the entire contents of which are incorporated herein by reference for all purposes.

### GOVERNMENTAL RIGHTS

This invention was made with government support under a small business innovation research award (2022-33530-37068) from the United States Department of Agriculture. The government has certain rights in this invention.

### FIELD OF THE INVENTION

The present disclosure generally relates to (1) a titanium redox flow battery comprising a titanium salt in an aqueous solution as the electrolyte for the negative side, and a porous nitrogen-enriched catalyst that promotes the redox reaction of titanium electrolytes; and (2) a binary redox flow battery comprising two redox follow battery units: an “E-to-C” unit converting electricity to the chemical energy in an electrolyte, and a “C-to-E” flow battery converting the chemical energy generated in the “E-to-C” battery to electricity. Shuttling electrolytes between “E-to-C” unit and the “C-to-E” unit via trains, boats, trucks, or pipelines will enable the off-grid transportation of harvested solar and/or wind energy between two separate locations.

A binary redox flow battery that separates its energy storage and energy discharge processes into two units. The electricity to chemical energy unit (“E-to-C unit”) converts electricity into the chemical energy that is stored in the positive side and negative side electrolytes, which will be transformed back into electricity in a separate chemical energy to electricity unit (“C-to-E unit”). The separation of two processes will allow the production and use of electricity in two different locations.

### BACKGROUND OF THE INVENTION

The first part of the present disclosure is related to a novel titanium redox flow battery comprising an anolyte having a titanium salt at the negative side. Although lithium-ion batteries are suitable for short-term energy storage (<4 hours), redox flow batteries are superior for long-duration energy storage (>10 hours) because of the separation of their power output and the stored energy. In addition, aqueous electrolyte-based flow batteries have improved fire-safety profiles. At present, all-vanadium flow batteries are the devices of choice for long-duration energy storage. Unfortunately, vanadium metal is very expensive and vanadium electrolytes typically contribute to ˜75% of the overall flow battery production expenditures. Vanadium makes 0.019% of the earth's crust, and vanadium is primarily mined in China, Russia, and South Africa, which may lead to supply chain concerns if all-vanadium flow batteries are widely adopted for large-scale energy storage.

An innovative strategy to reduce the flow battery costs is to adopt cheaper metal electrolytes. Titanium makes 0.57% of the earth's crust, and it only costs about 20% of that of vanadium. Titanium mines are widely distributed across Europe, Australia, and North America. As a result, using a titanium electrolyte as an anolyte makes economic sense and reduces the complexity of global supply chains.

In a titanium redox flow battery, a titanium salt in an acidic aqueous solution is used as an anolyte for the negative side, and its redox reaction in a H₂SO₄ solution is shown in Eq. 1:

Ti³⁺+H₂O→TiO²⁺+2H⁺+e⁻0.19V(vs SHE) (Eq. 1)

A distinctive advantage of using TiO²⁺/Ti³⁺ at the negative side is its redox potential out of the range of a competitive hydrogen evolution reaction, which reduces protons into hydrogen gas. This helps improve the energy efficiency of titanium redox flow batteries.

Unfortunately, the kinetics of the titanium redox reaction (Eq. 1) is sluggish, and thus, it is not easy to achieve high current density outputs during the discharge of a titanium redox flow battery. As a result. The overall power densities of titanium redox flow batteries are low. This may be the reason that publications are scarce on titanium redox flow batteries. To the best of our knowledge, only until after the ear 2020, Qiao, et al. (Chem. Eng. J., 2022, 434, 134588) reported a titanium-iron flow battery, and Li, et al. (Adv. Mater., 2020, 32, 2005036) reported a titanium-bromine flow battery, all of which used a commercial porous carbon/graphite felt as it is without further modifications.

The present invention discloses a novel nitrogen-enriched porous carbon catalyst that has improved the performance of the titanium electro-reduction reaction. Comparative experiments disclosed in the present patent suggest nitrogen-enriched porous carbon catalysts are superior to nascent carbon felts. Commercial carbon or graphite felts produced from polyacrylonitrile typically contain 0 wt % to 0.3 wt % of nitrogen. Our nitrogen-enriched carbon catalysts contain a nitrogen content ranging from 0.5 wt % to 25 wt %.

The second part of the present disclosure is related to a binary redox flow battery for the storage and off-grid transmission of energy/

The increased adoption of electric vehicles has added additional pressure on the aging grid system. Rural areas have abundant solar and wind resources to be harvested, but most end-users of clean electricity reside in major metropolitan areas. How to transmit clean energy from the countryside to major cities is a big challenge.

The present patent application discloses a novel binary redox flow battery to solve the aforementioned problem. A binary is comprised of two redox flow batteries: an “E-to-C” battery in a rural area converts wind or solar electricity to the chemical energy stored in electrolytes, which will be transported as a liquid fuel via, for example, pipelines, trains, trucks, and boats to a second flow battery in a metropolitan area hosting a “C-to-E” unit that converts the chemical energy in electrolytes back to electricity. The spent electrolytes can be transported back to the rural area for recharge. Such a binary redox flow battery will enable off-grid transmission of energy between two geographically separated locations.

### FIGURES

FIG. 1 shows a discharge graph of a titanium-iron redox flow battery comprised of a commercially untreated carbon felt or a porous nitrogen-enriched carbon catalyst. Under the same operation conditions, a porous nitrogen-enriched carbon catalyst shows better performance than the untreated carbon felt. The discharge curves of titanium-iron redox flow batteries comprised of porous nitrogen-enriched catalysts (CF-melamine-S—N2, CF-melamine-S—NH3, CF-melamine-P—N2, CF-melamine-P—NH3, and CF—NH3) against commercially available untreated carbon felt catalyst (untreated commercial CF). Experimental details can be found in Example 4.

FIG. 2 shows a graph which demonstrate the polarization curve. The polarization curve demonstrates that porous nitrogen-enriched carbon felts led to higher current densities and larger power densities of the flow battery. The polarization curves of titanium-iron redox flow batteries comprised of porous nitrogen-enriched catalysts (CF-melamine-S—N2, CF-melamine-S—NH3, CF-melamine-P—N2, CF-melamine-P—NH3, and CF—NH3) against commercially available untreated carbon felt catalyst (untreated commercial CF). Experimental details can be found in Example 4.

### SUMMARY OF THE INVENTION

In one embodiment of the present invention provides a titanium redox flow battery that employs an acidic aqueous solution comprising a titanium salt for the negative side and an acidic aqueous electrolyte having an acidic aqueous electrolyte selected from a group of an iron salt, a vanadium salt, a cerium salt, bromine, and its salts at the positive side. A porous nitrogen-enriched carbon catalyst is used to help improve the redox reactions at electrodes.

In a further embodiment is related to a binary redox flow battery comprised of an E-to-C unit and a separate C-to-E unit, which separately converts electricity to chemical energy in electrolytes and chemical energy to electricity, respectively. Electrolytes are in contact with both E-to-C and C-to-E units.

Other objects and features will be in part apparent and in part pointed out hereinafter.

### DETAILED DESCRIPTION OF THE INVENTION

In one embodiment, the present invention provides a titanium redox flow battery comprising porous nitrogen-enriched catalysts, two bipolar plates, an acidic aqueous electrolyte having a titanium salt for the negative side, and an acidic aqueous solution of a salt selected from a group of iron (Eq. 2), cerium (Eq. 3), bromine (Eq. 4), and vanadium (Eq. 5) at the positive side:

Fe³⁺+e⁻→Fe²⁺0.77v(vs SHE) (Eq. 2)

Ce⁴⁺+e⁻→Ce³⁺1.61V(vs SHE) (Eq. 3)

Br₂+2e⁻→2Br⁻1.09V(vs SHE) (Eq. 4)

V⁵⁺+e⁻→V⁴⁺1.0V(vs SHE) (Eq. 5)

As a result, a titanium-iron flow battery is comprised of the following overall redox reaction (Eq. 2-A):

Ti³⁺+H₂O+Fe³⁺→TiO²⁺+Fe²⁺+2H⁺0.58V (Eq. 2-A)

A titanium-cerium flow battery is comprised of the following overall redox reaction (Eq. 3-A):

Ti³⁺+H₂O+Ce⁴⁺→TiO²⁺+Ce³⁺+2H⁺1.42V (Eq. 3-A)

A titanium-bromine flow battery is comprised of the following overall redox reaction (Eq. 4-A):

2Ti³⁺+2H₂O+Br₂→2TiO²⁺+2Br⁻+4H⁺0.90V (Eq. 4-A)

A titanium-vanadium flow battery is comprised of the following overall redox reaction (Eq. 5-A):

Ti³⁺+H₂O+V⁵⁺→TiO²⁺+V⁴⁺+2H⁺0.81V (Eq. 5-A)

In this disclosure, “electrolyte” or “solution” all refer to an electrolytic solution. These aqueous electrolytes or solutions are also comprised of an acid selected from hydrochloric acid, hydrogen bromide, sulfuric acid, hydrogen iodide, nitric acid, phosphoric acid, and any combinations thereof. These acids help solubilize metal and bromine salts, and they also assist in the transportation of ions to reduce the internal resistance of the battery. Those skilled in the art will appreciate that the concentration of an acid in the aqueous solution will be determined by the solubility of the salts and the internal resistance of the battery.

Optionally, an additional salt can also be added to the electrolytic solution to facilitate ion transportation. Examples of these salts include NaCl, NaBr, NaI, NaF, KCl, KBr, KI, KF, NaHSO₄, Na₂SO₄, KHSO₄, K₂SO₄, NaH₂PO₄, Na₂HPO₄, Na₃PO₄, KH₂PO₄, K₂HPO₄, K₃PO₄, NaNO₃, and KNO₃.

For a titanium-bromine redox flow battery, bromine can be generated. Bromine is toxic and has a boiling point of 58.8° C. Sublimation or evaporation of Br₂ could lead to human health and environmental challenges. As a result, a water-soluble bromine complexing agent is preferred in a titanium-bromine battery. Br₂ can form a complex such as Br₃⁻, Br₅⁻, ClBr₂⁻ with a cation in water, which reduces the sublimation or evaporation of Br₂.

A water-soluble bromine complexing agent is usually a quaternary ammonium salt, or an imidazolium salt, or a pyridinium salt and its anion is usually a halide. Some examples include 1-ethyl-1-methylpyrrolidin-1-ium bromide, 4-ethyl-4-methylmorpholin-4-ium bromide, 1-ethyl-1-methylpiperidin-1-ium bromide, 2-pyridin-1-ium-1-ylethanol bromide, (2-(3-methylimidazol-3-ium-1-yl)ethanol chloride, 3-chloro-2-hydroxypropyltrimethylammonium chloride, and tetramethylammonium bromide.

Those skilled in the art will appreciate that the concentration of bromine, or metal salts, or an acid, or a water-soluble bromine complexing agent can vary. One needs to balance the battery cost and its performance.

Those skilled in the art will also appreciate that a titanium redox flow battery is also comprised of bipolar plates, gaskets, ion-permeable films, sealants, current collectors, endplates, bolts, nuts, pumps, storage tanks, pipelines, valves, a balance cell, and many other auxiliaries, including sensors, meters, power and energy management and monitoring systems.

An ion-permeable film or membrane refers to a porous polymeric membrane or an ion-exchange membrane. Examples of ion-exchange membranes include Nafion™ films, Aquivion™ films, sulfonated polysulfone films polybenzimidazole membranes, their derivatives, and any combinations thereof.

A challenge of a titanium redox flow battery is the slow kinetics of the titanium redox reaction. As a result, a titanium flow battery may suffer from low current-density outputs and low battery power densities.

A second embodiment of the present disclosure provides a porous nitrogen-enriched carbon catalyst that contains a nitrogen content ranging from 0.5 wt % to 25 wt %.

According to the HSAB theory, Ti³⁺/TiO²⁺ are hard acids, which have strong affinities towards a hard base containing a nitrogen atom. As a result, a nitrogen-enriched carbon catalyst potentially has better contact with Ti³⁺ and TiO²⁺ cations. In addition, the presence of nitrogen atoms improves the hydrophilicity of the porous carbon felt, which also facilitates the redox reaction of titanium electrolytes. As a result, the enrichment of the nitrogen content can help overcome the sluggish kinetics of the titanium redox reaction.

It is known that porous carbon felts enriched with nitrogen and phosphine showed better activities than untreated commercial carbon felts in vanadium-vanadium redox flow batteries. It is a surprise to find that the incorporation of nitrogen and sulfur into porous carbon felts led to better catalysts for a titanium redox flow battery.

“Carbon” or “graphite” all refer to carbonaceous materials produced from hydrocarbon-based polymers via pyrolysis processes. Commercial carbon or graphite felts produced from polyacrylonitrile typically contain 0 wt % to 0.3 wt % of nitrogen. Commercial carbon or graphite felts produced from other polymers, such as polyesters, contain much lower nitrogen contents, typically at 0 wt % of nitrogen.

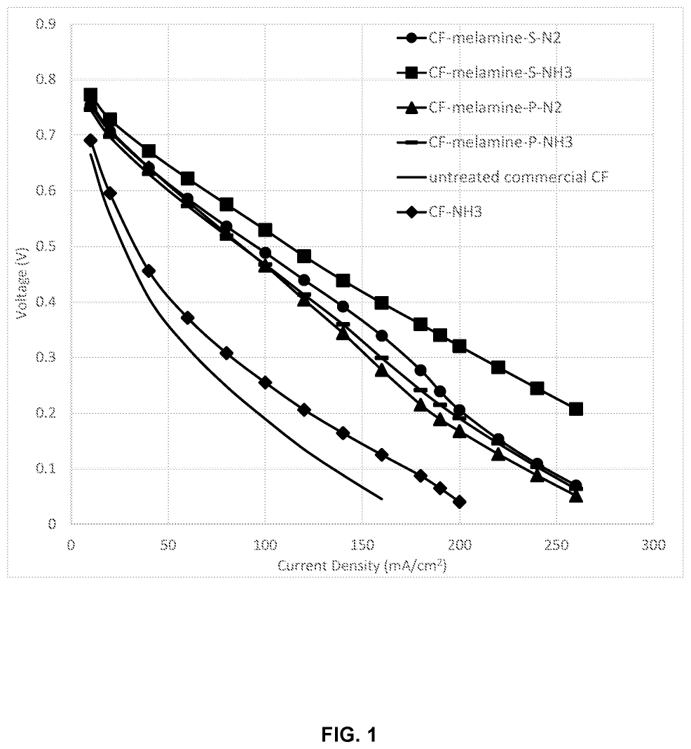

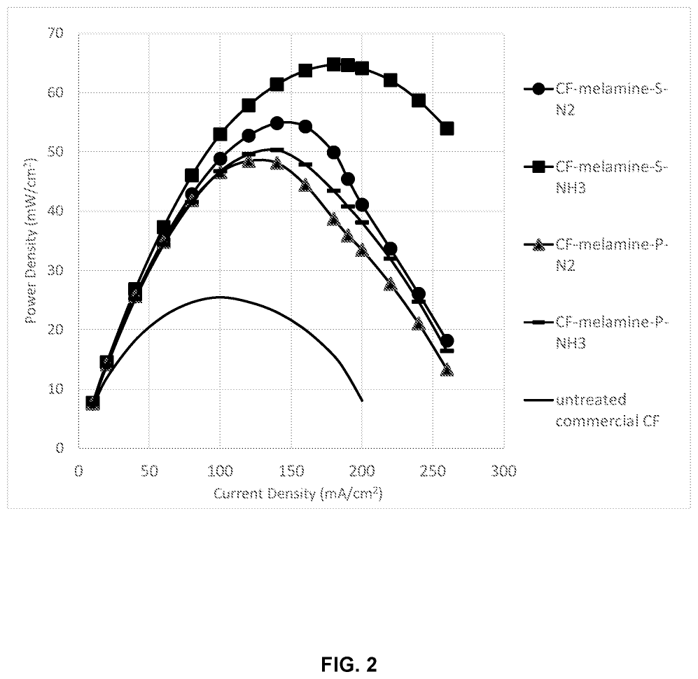

FIG. 1 shows the discharge graph of a titanium-iron redox flow battery comprised of a commercially untreated carbon felt or a porous nitrogen-enriched carbon catalyst. Under the same operation conditions, a porous nitrogen-enriched carbon catalyst shows better performance than the untreated carbon felt. Polarization curves (FIG. 2) demonstrate that porous nitrogen-enriched carbon felts led to higher current densities and larger power densities of the flow battery. Examples in the present disclosure also support the superior catalytic activities of our porous nitrogen-enriched carbon catalysts over commercial untreated carbon catalysts.

A third embodiment provides a method of producing a porous nitrogen-enriched catalyst a porous nitrogen-enriched carbon catalyst is produced by heating a porous carbon or graphite felt, or a carbon or graphite paper, or carbon or graphite cloth in contact with a nitrogen-containing compound selected from ammonia, urea, thiourea, hydrazine, ammonium hydroxide, melamine, guanidine, metaformin, cyanuric acid, their derivatives, and any combination thereof, to a temperature between 200° C. and 1,200° C. for a period of between 1 second to 24 hours, preferably between 30 minutes and 300 minutes, and further preferably between 60 minutes and 120 minutes. Optionally, a sulfur-containing or phosphine-containing chemical can be added to the mixture for heat treatment. The heat treatment process can be under nitrogen, argon, ammonia, air, or any combination thereof.

Another embodiment offers a binary redox flow battery comprised of two separate units:

a redox flow battery unit converting electricity to the chemical energy of electrolytes (“E-to-C unit”), comprised of

a positive compartment having an electrolyte (“positive-side-electrolyte”), a bipolar plate, and a porous catalyst layer attached directly to a surface of the bipolar plate;

a negative compartment having an electrolyte (“negative-side-electrolyte”), a bipolar plate, and a porous catalyst layer attached directly to a surface of the bipolar plate;

and an ion-permeable membrane separating said the positive and negative compartments.

a second redox flow battery unit converting the chemical energy of electrolytes to electricity (“C-to-E unit”), comprised of

a positive compartment having an electrolyte (“positive-side-electrolyte”), a bipolar plate, and a porous catalyst layer attached directly to a surface of the bipolar plate;

a negative compartment comprising an electrolyte (“negative-side-electrolyte”), a bipolar plate, and a porous catalyst layer attached directly to the surface of a bipolar plate;

and an ion-permeable membrane separating said the positive and negative compartments.

The positive-side-electrolyte contacts the positive compartments of both the E-to-C unit and the C-to-E unit, and the negative-side-electrolyte contacts the negative compartments of both the E-to-C unit and the C-to-E unit.

In the E-to-C unit, the negative compartment may be electronically connected to the negative side of an external power source via a current connector. Another current connector may be used to connect the positive compartment of the E-to-C unit to the positive side of the external power source. During the electricity charging process, at the negative side, a metal cation will gain an electron while at the positive side, a metal cation will lose an electron.

The negative-side-electrolyte in the E-to-C unit can be comprised of, for example, TiOSO₄, sulfuric acid and water, which may be pumped to the negative compartment of the C-to-E unit. A reverse reaction that oxidizes Ti³⁺ back to TiO²⁺ will release an electron at the negative side of the C-to-E unit. An example of this process is shown in Eq. 1 for the redox reaction of titanium.

The positive-side-electrolyte in the E-to-C unit can be comprised of, for example, a metal salt, bromine, sulfuric acid and water, which will then be pumped to the positive compartment of the C-to-E unit. Examples of the redox reactions of the positive-side-electrolytes are shown in Eq. 2, Eq. 3, Eq. 4, and Eq. 5.

In a C-to-E unit, the negative compartment may be electronically connected to the negative side of an electrical load via a current connector. Another current connector may be used to connect the positive compartment of the C-to-E unit to the positive side of the electrical load.

The positive-side-electrolyte and the negative-side-electrolyte are shuttled between the E-to-C unit and the C-to-E unit via a pipeline, a tube, or two storage tanks that can be transported via a truck, a train, a boat, and an aircraft between two locations.

The separation of the E-to-C unit and the C-to-E unit may allow the adoption of more economical materials other than expensive graphite plates in both positive and negative compartments.

Those skilled in the art will appreciate that auxiliaries and additional parts such as a rebalancing cell, pumps, current collectors, endplates, frames, sealants may be used in the binary redox flow battery.

Those skilled in the art also understands both the E-to-C and C-to-E units can convert electricity to the chemical energy in electrolytes as well as convert the chemical energy in electrolytes back to electricity. Each unit can be used independently as a conventional redox flow battery that is a secondary cell enabling reversible redox reactions inside the cell.

### Definitions

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

The term “ion-conductive”, or “ion-exchange”, or “ion-permeable”, “ion permeable” or is that an ion can be transported from one site to another. Ionic conduction can lead to an electric current.

The term “electrolyte” refers to a material that transport ions. “Electrolytic” is an adjective word of “electrolyte”.

The term “cation-conductive” or “cation-exchange” refers to the migration of a positively charged ion from one side to another in a medium.

The term “anion-conductive” or “anion-exchange” refers to the migration of a negatively charged ion from one side to another in a medium.

The term “anolyte” or “negative-side-electrolyte” refers to an electrolytic material passing through the negative side of a titanium redox flow battery.

The term “catholyte” or “positive-side-electrolyte” refers to an electrolytic material passing through the positive side of a titanium redox flow battery.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

The terms “selected”, “chosen” and “or” refer to make one or more choices including a combination of choices from a number of possibilities.

The term “conduit” refers to a tube of metal, plastic, or other material used to convey a fluid or semi-fluid substance. The conduit can have any kinds of sizes.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in a combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

The following examples illustrate various embodiments of the disclosure. Chemicals and organic solvents mentioned below were purchased from Aldrich (Milwaukee, Wis.) or Acros Organics (Pittsburgh, Pa.) and used as received. Water was obtained from a Milli-Q water system purchased from Millipore Corporation (Milford, Mass.). The heavy metal and bacterial contaminant levels in Milli-Q water were below 10 parts per billion. The membranes of NAFION® were purchased from Sigma Aldrich. CHI1127C Electrochemical Analyzer from CHI Instruments, Inc. (Austin, Tex.). AvCarb® G150-12 and C200-8 carbon felts were purchased from Fisher Scientific, and for comparison purposes, carbon felts were also obtained from Liaoyang J-Carbon Materials Co., Ltd., China. Carbon papers AvCarb® GDS2240 (carbon papers) and Spectracarb 2050A-1050 were purchased from Fuel Cell Earth (Woburn, Mass.). Hydrophilic carbon cloth was obtained from Fuel Cell Store (College Station, Tex.).

### Example 1: Synthesis of a Porous Nitrogen-Enriched Carbon Catalyst Using Phosphodiester Coupling

A mixture of commercial carbon cloth (1.67 g, nitrogen content: 0.0 wt %; phosphine content: 0.0 wt %; sulfur content: 0.0 wt %), a carbon felt (3.23 g, nitrogen content: 0.3 wt %; phosphine content: 0.0 wt %; sulfur content: 0.0 wt %), and a carbon paper (1.49 g, nitrogen content 0.2 wt %; phosphine content: 0.0 wt %; sulfur content: 0.0 wt %) were immersed in 175 mL DMAc dissolved with 60 mL diethylphosphite. Then, 12 g dibenzoyl peroxide was added in portions. The mixture was stirred at 60° C. for 72 h. DMAc was removed. Then, the carbon felt, paper, and cloth were washed with water (100 mL×5). Then, a mixture of 25 g melamine and 200 mL water was added to the mixture. The mixture was stirred at ambient temperature for 24 h.

Then, the carbon cloth was heated under nitrogen to 650° C. in a tube furnace at 1° C./min and at 650° C. for 2 h. The carbon cloth was then cooled down to ambient temperature. Before a redox flow battery experiment, the carbon cloth was activated by being heated to 600° C. under ambient air for 90 minutes to yield CC-melamine-P—N2 (nitrogen content: 9.65 wt %; phosphine content: 1.81 wt %; sulfur: 0.0 wt %).

The carbon cloth was heated under anhydrous ammonia gas to 650° C. in a tube furnace at 1° C./min and at 650° C. for 2 h. The carbon cloth was then cooled down to ambient temperature. Before a redox flow battery experiment, the carbon cloth was activated by being heated to 600° C. under ambient air for 90 minutes to yield CC-melamine-P—NH3 (nitrogen content: 11.21 wt %; phosphine content: 1.58 wt %; sulfur: 0.0 wt %).

The carbon felt was heated under nitrogen to 650° C. in a tube furnace at 1° C./min and at 650° C. for 2 h. The carbon felt was then cooled down to ambient temperature. Before a redox flow battery experiment, the carbon felt was activated by being heated to 600° C. under ambient air for 90 minutes to yield CF-melamine-P—N2 (nitrogen content: 9.98 wt %, phosphine content: 2.07 wt %; sulfur: 0.0 wt %).

The carbon felt was heated under anhydrous ammonia gas to 650° C. in a tube furnace at 1° C./min and at 650° C. for 2 h. The carbon felt was then cooled down to ambient temperature. Before a redox flow battery experiment, the carbon felt was activated by being heated to 600° C. under ambient air for 90 minutes to yield CF-melamine-P—NH3 (nitrogen content: 14.76 wt %; phosphine content: 1.42 wt %; sulfur: 0.0 wt %).

The carbon paper was heated under nitrogen to 650° C. in a tube furnace at 1° C./min and at 650° C. for 2 h. The carbon paper was then cooled down to ambient temperature. Before a redox flow battery experiment, the carbon paper was activated by being heated to 600° C. under ambient air for 90 minutes to yield CP-melamine-P—N2 (nitrogen content: 2.86 wt %, phosphine content: 0.75 wt %; sulfur: 0.0 wt %).

The carbon paper was heated under anhydrous ammonia gas to 650° C. in a tube furnace at 1° C./min and at 650° C. for 2 h. The carbon paper was then cooled down to ambient temperature. Before a redox flow battery experiment, the carbon paper was activated by being heated to 600° C. under ambient air for 90 minutes to yield CP-melamine-P—NH3 (nitrogen content: 3.27 wt %, phosphine content: 0.54 wt %; sulfur: 0.0 wt %).

### Example 2: Synthesis of a Porous Nitrogen-Enriched Carbon Catalyst Using Thionyl Coupling

A mixture of commercial carbon cloth (1.7 g, nitrogen content: 0.0 wt %; phosphine content: 0.0 wt %; sulfur content: 0.0 wt %), a carbon felt (1.9 g, nitrogen content: 0.3 wt %; phosphine content: 0.0 wt %; sulfur content: 0.0 wt %), and a carbon paper (3.3 g, nitrogen content 0.2 wt %; phosphine content: 0.0 wt %; sulfur content: 0.0 wt %) was stirred in a mixture of 30 mL thionly chloride and 50 mL chloroform at room temperature for 24 h. The solvent was removed, and the felt was washed with chloroform 100 mL×3. The felt was stirred in a mixture of 25 g melamine in 200 mL water at ambient temperature for 24 h.

Then, the carbon felt was heated under nitrogen to 650° C. in a tube furnace at 1° C./min and at 650° C. for 2 h. The carbon cloth was then cooled down to ambient temperature. Before a redox flow battery experiment, the carbon cloth was activated by being heated to 600° C. under ambient air for 90 minutes to yield CF-melamine-S—N2 (nitrogen content: 11.01 wt %; sulfur content: 3.17 wt %; phosphine: 0.0 wt %).

The carbon felt was heated under anhydrous ammonia gas to 650° C. in a tube furnace at 1° C./min and at 650° C. for 2 h. The carbon felt was then cooled down to ambient temperature. Before a redox flow battery experiment, the carbon felt was activated by being heated to 600° C. under ambient air for 90 minutes to yield CF-melamine-S—NH3 (nitrogen content: 15.82 wt %, sulfur content: 2.86 wt %; phosphine: 0.0 wt %).

The carbon paper was heated under nitrogen to 650° C. in a tube furnace at 1° C./min and at 650° C. for 2 h. The carbon paper was then cooled down to ambient temperature. Before a redox flow battery experiment, the carbon paper was activated by being heated to 600° C. under ambient air for 90 minutes to yield CP-melamine-S—N2 (nitrogen content: 3.11 wt %, phosphine content: 0.0 wt %; sulfur: 1.0 wt %).

The carbon paper was heated under anhydrous ammonia gas to 650° C. in a tube furnace at 1° C./min and at 650° C. for 2 h. The carbon paper was then cooled down to ambient temperature. Before a redox flow battery experiment, the carbon paper was activated by being heated to 600° C. under ambient air for 90 minutes to yield CP-melamine-S—NH3 (nitrogen content: 4.99 wt %, phosphine content: 0.0 wt %; sulfur: 0.9 wt %).

### Example 3: Synthesis of Other Porous Nitrogen-Enriched Carbon Catalysts

A carbon felt (10 cm×10 cm) was heated under anhydrous ammonia gas to 650° C. in a tube furnace at 1° C./min and at 650° C. for 2 h. The carbon felt was then cooled down to ambient temperature. Before a redox flow battery experiment, the carbon felt was activated by being heated to 600° C. under ambient air for 90 minutes to yield CF—NH3 (nitrogen content: 2.37 wt %, sulfur content: 0.0 wt %; phosphine: 0.0 wt %).

A mixture of a commercial carbon felt (3.23 g, nitrogen content: 0.3 wt %; phosphine content: 0.0 wt %; sulfur content: 0.0 wt % was immersed in 35 mL DMAc dissolved with 12 mL diethylphosphite. Then, 2.4 g dibenzoyl peroxide was added in portions. The mixture was stirred at 60° C. for 72 h. DMAc was removed. Then, the carbon felt was heated under anhydrous ammonia gas to 650° C. in a tube furnace at 1° C./min and at 650° C. for 2 h. The carbon felt was then cooled down to ambient temperature. Before a redox flow battery experiment, the carbon felt was activated by being heated to 600° C. under ambient air for 90 minutes to yield CF—P—NH3 (nitrogen content: 6.01 wt %, sulfur content: 0.0 wt %; phosphine: 1.51 wt %).

### Example 4: Comparative Studies of Porous Nitrogen-Enriched Carbon Catalysts Against an Untreated Porous Carbon Catalyst in a Titanium-Iron Redox Flow Battery

An untreated carbon felt 6×8 cm² (thickness 5 mm) (nitrogen content: 0.3 wt %; phosphine content: 0.0 wt %; sulfur content: 0.0 wt %) was used in a titanium-iron redox flow battery by adapting the experimental procedures reported by Qiao, et al. (Chem. Eng. J., 2022, 434, 134588) who used an untreated carbon felt as the catalyst: Nafion 212 was used as the proton-conductive membrane. A mixture of 0.7 M Ti³⁺ and TiO²⁺ in 3M H₂SO₄ was used as the anolyte while the mixture of 0.7 M Fe²⁺ and Fe³⁺ in 3M H₂SO₄ was employed as the catholyte. The flow rates are 50 mL/min for both sides. The battery was evaluated with the cut-off voltage of 0.9 V and 0.3 V at the current density varying from 40 to 120 mA/cm².

In comparison, a porous nitrogen-enriched carbon catalyst 6×8 cm² was used as the replacement of the untreated carbon felt. To this end, CF-melamine-S—N2, CF-melamine-S—NH3, CF-melamine-P—NH3, CF—P—NH3, and CF—NH3 were evaluated in the battery using similar experimental conditions as those for the untreated carbon felt.

The performance of the battery comprising different catalysts was shown in FIGS. 1 and 2.

### Example 5: Comparative Studies of Porous Nitrogen-Enriched Carbon Catalysts Against an Untreated Porous Carbon Catalyst in a Titanium-Bromine Redox Flow Battery

An untreated carbon felt 6×8 cm² (thickness 5 mm) (nitrogen content: 0.3 wt %; phosphine content: 0.0 wt %; sulfur content: 0.0 wt %) was used in a titanium-bromine redox flow battery by adapting the experimental procedures reported by Li, et al. (Adv. Mater., 2020, 32, 2005036) who used an untreated carbon felt as the catalyst: Nafion 115 was used as the proton-conductive membrane. An aqueous mixture of 1 M Ti(SO₄)₂, 1 M HBr, 2 M HCl, and 0.5 M 3-chloro-2-hydroxypropyltrimethylammonium chloride as the electrolyte for both sides. The flow rate of the electrolyte was 50-60 mL/min. The charge and discharge limited voltages were set as 1.4V and 0.1 V, respectively.

In comparison, a porous nitrogen-enriched carbon catalyst 6×8 cm² was used as the replacement of the untreated carbon felt. To this end, CF-melamine-S—N2, CF-melamine-S—NH3, CF-melamine-P—NH3, and CF—NH3 was evaluated in the battery using similar experimental conditions as those for the untreated carbon felt.

The energy efficiencies of the untreated carbon felt, CF-melamine-S—N2, CF-melamine-S—NH3, CF-melamine-P—NH3, and CF—NH3 are 82%, 85%, 88%, 84%, and 84%, respectively at 70% SOC and at 40 mA/cm². The maximal power output of the flow battery comprising the untreated carbon felt, CF-melamine-S—N2, CF-melamine-S—NH3, CF-melamine-P—NH3, and CF—NH3 are 27 mW/cm², 73 mW/cm², 97 mW/cm², 65 mW/cm², 41 mW/cm², respectively.

### Example 6: Comparative Studies of Porous Nitrogen-Enriched Carbon Catalysts Against an Untreated Porous Carbon Catalyst in a Titanium-Cerium Redox Flow Battery

An untreated carbon felt 2×2 cm² (thickness 5 mm) (nitrogen content: 0.3 wt %; phosphine content: 0.0 wt %; sulfur content: 0.0 wt %) was used in a titanium-cerium redox flow battery: Nafion 212 was used as the proton-conductive membrane. An aqueous mixture of 0.7 M TiOSO4 and 2.5 M H₂SO₄ as the anolyte while a mixture of 0.35 M Ce₂(SO₄)₃ in 5 M methanesulfonic acid in water. The flow rate of the electrolyte was 10 mL/min. The charge and discharge limited voltages were set as 1.7V and 0.0 V, respectively.

In comparison, a porous nitrogen-enriched carbon catalyst 2×2 cm² was used as the replacement of the untreated carbon felt. To this end, CF-melamine-S—N2, CF-melamine-S—NH3, CF-melamine-P—NH3, and CF—NH3 was evaluated in the battery using similar experimental conditions as those for the untreated carbon felt.

The energy efficiencies of the untreated carbon felt, CF-melamine-S—N2, CF-melamine-S—NH3, CF-melamine-P—NH3, and CF—NH3 are 68%, 78%, 82%, 80%, and 75%, respectively at 90% SOC and at 140 mA/cm².

### Example 7: A Binary Vanadium-Vanadium Redox Flow Battery

Two single-cell batteries were used. Each of the cells is comprised of two CF-melamine-S—NH3 catalysts (2 cm×2 cm) for anode and cathode, respectively. A Nafion 212 membrane was employed to separate the two chambers. The flow rates were maintained at 10 mL/min.

The 1^{st} battery (“E-to-C” unit) used an aqueous electrolyte (50 mL) comprised of 1 M VOSO₄ and 5 M H₂SO₄ as the “positive-side-electrolyte” while a 50 mL electrolyte of 0.5 M V₂(SO₄)₃ and 5 M H₂SO₄ as the “negative-side-electrolyte”. The battery was charged at a constant voltage of 1.7V until the SOC reached 90%.

Then, the positive-side-electrolyte was fed to the positive side of a second flow battery (“C-to-E” unit) having the same cell configuration while the negative-side-electrolyte was pumped through the negative side of the “C-to-E” unit at a flow rate of 10 mL/min. The “C-to-E” unit was discharged until 0V at 100 mA/cm².

### Example 8: A Binary Titanium-Iron Redox Flow Battery

Two single-cell batteries were used. Each of the cells is comprised of two CF-melamine-S—NH3 catalysts (2 cm×2 cm) for anode and cathode, respectively. A Nafion 212 membrane was employed to separate the two chambers. The flow rates were maintained at 10 mL/min.

The 1^{st} battery (“E-to-C” unit) used a mixture of 0.7 M Ti³⁺ and TiO²⁺ in 3M H₂SO₄ was used as the negative-side-electrolyte while the mixture of 0.7 M Fe²⁺ and Fe³⁺ in 3M H₂SO₄ was employed as the positive-side-electrolyte. The battery was charged at a constant voltage of 1.3V until the SOC reached 90%.

Then, the positive-side-electrolyte was fed to the positive side of a second flow battery (“C-to-E” unit) having the same cell configuration while the negative-side-electrolyte was pumped through the negative side of the “C-to-E” unit at a flow rate of 10 mL/min. The “C-to-E” unit was discharged until 0V at 60 mA/cm².

### Example 9: A Binary Titanium-Bromine Redox Flow Battery

Two single-cell batteries were used. Each of the cells is comprised of two CF-melamine-S—NH3 catalysts (2 cm×2 cm) for anode and cathode, respectively. A Nafion 212 membrane was employed to separate the two chambers. The flow rates were maintained at 10 mL/min.

The 1^{st} battery (“E-to-C” unit) used a mixture of an aqueous mixture of 1 M Ti(SO₄)₂, 1 M HBr, 2 M HCl, and 0.5 M 3-chloro-2-hydroxypropyltrimethylammonium chloride as both negative-side-electrolyte and both-side-electrolyte. The battery was charged at a constant voltage of 1.4V until the SOC reached 90%.

Then, the positive-side-electrolyte was fed to the positive side of a second flow battery (“C-to-E” unit) having the same cell configuration while the negative-side-electrolyte was pumped through the negative side of the “C-to-E” unit at a flow rate of 10 mL/min. The “C-to-E” unit was discharged until 0.1V at 40 mA/cm².

### Example 10: A Binary Titanium-Cerium Redox Flow Battery

Two single-cell batteries were used. Each of the cells is comprised of two CF-melamine-S—NH3 catalysts (2 cm×2 cm) for anode and cathode, respectively. A Nafion 212 membrane was employed to separate the two chambers. The flow rates were maintained at 10 mL/min.

The 1^{st} battery (“E-to-C” unit) used an aqueous mixture of 0.7 M TiOSO4 and 2.5 M H₂SO₄ as the negative-side-electrolyte while a mixture of 0.35 M Ce₂(SO₄)₃ in 5 M methanesulfonic acid in water as the positive-side-electrolyte. The battery was charged at a constant voltage of 1.7V until the SOC reached 90%.

Then, the positive-side-electrolyte was fed to the positive side of a second flow battery (“C-to-E” unit) having the same cell configuration while the negative-side-electrolyte was pumped through the negative side of the “C-to-E” unit at a flow rate of 10 mL/min. The “C-to-E” unit was discharged until 0.0V at 40 mA/cm².

What is claimed is:

1. A titanium redox flow battery, comprising:
a positive electrode having a bipolar plate, a porous nitrogen-enriched catalyst attached directly to a surface of the bipolar plate, and a catholyte electrolyte;
a negative electrode having a bipolar plate, a porous nitrogen-enriched carbon catalyst attached directly to a surface of the bipolar plate, and an anolyte electrolyte;
and an ion-permeable membrane separating said the positive and negative electrodes;
wherein,
an anolyte electrolyte is comprised of a titanium salt, and optionally a second electrolytic material selected from a group of an iron salt, a vanadium salt, a cerium salt, bromine and its derivatives, a water-soluble bromine complexing agent, and any combination thereof, in an aqueous acidic, or basic solution;
a catholyte electrolyte is comprised of an electrolytic material selected from a group of an iron salt, a cerium salt, bromine and its derivatives, a water-soluble bromine complexing agent, and any combination thereof, and optionally a titanium salt, in an aqueous acidic or basic solution;
an ion-permeable membrane is selected from a group of a cation-conductive membrane, an anion-exchange membrane, and a porous membrane;
a porous nitrogen-enriched carbon catalyst is selected from a group of carbon or graphite felts, carbon or graphite papers, and carbon or graphite cloth, containing a nitrogen content ranging from 0.5 wt % to 50 wt %, and optionally a sulfur or phosphine content ranging from 0.5 wt % to 30 wt %.
wherein,
a titanium salt has a cation selected from Ti³⁺, Ti⁴⁺, and TiO²⁺, and an anion;
an iron salt has a cation of either Fe³⁺ or Fe²⁺ and an anion;
a cerium salt has a Ce⁴⁺ or Ce³⁺ cation and an anion;
bromine and its derivatives are selected from a group of Br₂, Br⁻, Br³⁻, Br⁵⁻, BrCl₂⁻, and a cation;
a water-soluble bromine complexing agent is a quaternary ammonium salt, or an imidazolium salt, or a pyridinium salt.

2. The titanium redox flow battery according to claim 1,
wherein,
an anolyte electrolyte is comprised of a titanium salt and optionally a second electrolytic material selected from a group of an iron salt, a cerium salt, bromine and its derivatives, a water-soluble bromine complexing agent, and any combination thereof, in an aqueous acidic solution;
a catholyte electrolyte is comprised of an electrolytic material selected from a group of an iron salt, a vanadium salt, a cerium salt, bromine and its derivatives, a water-soluble bromine complexing agent, and any combination thereof, and optionally a titanium salt, in an aqueous acidic solution;
a porous nitrogen-enriched carbon catalyst is selected from a group of carbon or graphite felts, carbon or graphite papers, and carbon or graphite cloth, containing a nitrogen content ranging from 0.8 wt % to 30 wt %, and optionally a sulfur or phosphine content ranging from 0.8 wt % to 30 wt %.

3. The titanium redox flow battery according to claim 2,
wherein,
an anolyte electrolyte is comprised of a titanium salt and optionally a second electrolytic material selected from a group of an iron salt, bromine and its derivatives, a water-soluble bromine complexing agent, and any combination thereof, in an aqueous acidic solution;
a catholyte electrolyte is comprised of an electrolytic material selected from a group of an iron salt, bromine and its derivatives, a water-soluble bromine complexing agent, and any combination thereof, and optionally a titanium salt in an aqueous acidic solution;
a porous nitrogen-enriched carbon catalyst is selected from a group of carbon or graphite felts, and carbon or graphite papers, containing a nitrogen content ranging from 1.0 wt % to 25 wt %, and optionally a sulfur or phosphine content ranging from 1.0 wt % to 25 wt %.
wherein,
a water-soluble bromine complexing agent is selected from a group of 1-ethyl-1-methylpyrrolidin-1-ium halide, 4-ethyl-4-methylmorpholin-4-ium halide, 1-ethyl-1-methylpiperidin-1-ium halide, 2-pyridin-1-ium-1-ylethanol halide, (2-(3-methylimidazol-3-ium-1-yl)ethanol halide, 3-chloro-2-hydroxypropyltrimethylammonium halide, and tetramethylazanium halide.

4. The titanium redox flow battery according to claim 3,
wherein,
an anolyte electrolyte is comprised of a titanium salt and optionally a second electrolytic material selected from bromine and its derivatives, a water-soluble bromine complexing agent, and any combination thereof, in an aqueous acidic solution;
a catholyte electrolyte is comprised of an electrolytic material selected from a group of bromine and its derivatives, a water-soluble bromine complexing agent, and any combination thereof, and optionally a titanium salt in an aqueous acidic solution;
a porous nitrogen-enriched carbon catalyst is selected from a group of carbon or graphite felts, and carbon or graphite papers, containing a nitrogen content ranging from 1.0 wt % to 20 wt %, and optionally a sulfur content ranging from 1.0 wt % to 20 wt %.

5. The titanium redox flow battery according to claim 3,
wherein,
an anolyte electrolyte is comprised of a titanium salt and optionally a second electrolytic material is an iron salt, in an aqueous acidic solution;
a catholyte electrolyte is comprised of an iron salt and optionally a titanium salt in an aqueous acidic solution;
a porous nitrogen-enriched carbon catalyst is selected from a group of carbon or graphite felts, and carbon or graphite papers, containing a nitrogen content ranging from 1.0 wt % to 20 wt %, and optionally a sulfur content ranging from 1.0 wt % to 20 wt %.

6. A titanium redox flow battery, comprising
a positive electrode having a bipolar plate, a porous nitrogen-enriched catalyst attached directly to a surface of the bipolar plate, and a catholyte electrolyte;
a negative electrode having a bipolar plate, a porous nitrogen-enriched carbon catalyst attached directly to a surface of the bipolar plate, and an anolyte electrolyte;
and an ion-permeable membrane separating said the positive and negative electrodes;
wherein,
an anolyte electrolyte is comprised of a titanium salt, and optionally a second electrolytic material selected from a group of an iron salt, a vanadium salt, a cerium salt, bromine and its derivatives, a water-soluble bromine complexing agent, and any combination thereof, in an aqueous acidic, or basic solution;
a catholyte electrolyte is comprised of an electrolytic material selected from a group of an iron salt, a vanadium salt, a cerium salt, bromine and its derivatives, a water-soluble bromine complexing agent, and any combination thereof, and optionally a titanium salt, in an aqueous acidic or basic solution;
an ion-permeable membrane is selected from a group of a cation-conductive membrane, an anion-exchange membrane, and a porous membrane;
a porous nitrogen-enriched carbon catalyst is produced by heating a porous carbon or graphite felt, or a carbon or graphite paper, or carbon or graphite cloth in contact with a nitrogen-containing compound selected from ammonia, urea, thiourea, hydrazine, ammonium hydroxide, melamine, guanidine, metaformin, cyanuric acid, their derivatives, and any combination thereof, to a temperature between 200° C. and 1,200° C. for a period of between 1 second to 24 hours, preferably between 30 minutes and 300 minutes, and further preferably between 60 minutes and 120 minutes. Optionally, a second sulfur-containing or phosphine-containing chemical can be added to the mixture for heat treatment. The heat treatment process can be under nitrogen, argon, ammonia, air, or any combination thereof.
wherein,
a titanium salt has a cation selected from Ti³⁺, Ti⁴⁺, and TiO²⁺, and an anion;
an iron salt has a cation of either Fe³⁺ or Fe²⁺ and an anion;
a cerium salt has a Ce⁴⁺ or Ce³⁺ cation and an anion;
bromine and its derivatives are selected from a group of Br₂, Br⁻, Br³⁻, Br⁵⁻, BrCl₂⁻, and a cation;
a water-soluble bromine complexing agent is a quaternary ammonium salt, or an imidazolium salt, or a pyridinium salt.

7. The titanium redox flow battery according to claim 6,
wherein,
an anolyte electrolyte is comprised of a titanium salt and optionally a second electrolytic material selected from a group of an iron salt, bromine and its derivatives, a water-soluble bromine complexing agent, and any combination thereof, in an aqueous acidic solution;
a catholyte electrolyte is comprised of an electrolytic material selected from a group of an iron salt, bromine and its derivatives, a water-soluble bromine complexing agent, and any combination thereof, and optionally a titanium salt, in an aqueous acidic solution.
a porous nitrogen-enriched carbon catalyst is produced by heating a porous carbon or graphite felt, or a carbon or graphite paper, or carbon or graphite cloth in contact with a nitrogen-containing compound selected from ammonia, urea, thiourea, hydrazine, ammonium hydroxide, melamine, and any combination thereof, to a temperature between 300° C. and 1,000° C. for a period of between 30 minutes and 300 minutes, and further preferably between 60 minutes and 120 minutes. Optionally, a second sulfur-containing or phosphine-containing chemical can be added to the mixture for heat treatment. The heat treatment process can be under nitrogen, ammonia, air, or any combination thereof.

8. The titanium redox flow battery according to claim 7,
wherein,
an anolyte electrolyte is comprised of a titanium salt and optionally a second electrolytic material is an iron salt, in an aqueous acidic solution;
a catholyte electrolyte is comprised of an iron salt and optionally a titanium salt in an aqueous acidic solution;
a porous nitrogen-enriched carbon catalyst is produced by heating a porous carbon or graphite felt, or a carbon or graphite paper, or carbon or graphite cloth in contact with a nitrogen-containing compound selected from ammonia, ammonium hydroxide, melamine, and any combination thereof, to a temperature between 400° C. and 900° C. for a period between 60 minutes and 120 minutes. Optionally, a sulfur-containing chemical selected from thionly chloride, thiourea, sodium sulfate, ammonium sulfate, potassium sulfate, chlorosulfonic acid, and sulfonic acid can be added to the mixture for heat treatment. The heat treatment process can be under nitrogen, ammonia, air, or any combination thereof.

9. The titanium redox flow battery according to claim 7,
wherein,
an anolyte electrolyte is comprised of a titanium salt and optionally a second electrolytic material selected from a group of bromine and its derivatives, a water-soluble bromine complexing agent, and any combination thereof, in an aqueous acidic solution;
a catholyte electrolyte is comprised of an electrolytic material selected from a group of bromine and its derivatives, a water-soluble bromine complexing agent, and any combination thereof, and optionally a titanium salt in an aqueous acidic;
a water-soluble bromine complexing agent is selected from a group of 1-ethyl-1-methylpyrrolidin-1-ium halide, 4-ethyl-4-methylmorpholin-4-ium halide, 1-ethyl-1-methylpiperidin-1-ium halide, 2-pyridin-1-ium-1-ylethanol halide, (2-(3-methylimidazol-3-ium-1-yl)ethanol halide, 3-chloro-2-hydroxypropyltrimethylammonium halide, and tetramethylazanium halide.
a porous nitrogen-enriched carbon catalyst is produced by heating a porous carbon or graphite felt, or a carbon or graphite paper, or carbon or graphite cloth in contact with a nitrogen-containing compound selected from ammonia, ammonium hydroxide, melamine, and any combination thereof, to a temperature between 400° C. and 900° C. for a period between 60 minutes and 120 minutes. Optionally, a sulfur-containing chemical selected from thionly chloride, thiourea, sodium sulfate, ammonium sulfate, potassium sulfate, chlorosulfonic acid, and sulfonic acid can be added to the mixture for heat treatment. The heat treatment process can be under nitrogen, ammonia, air, or any combination thereof.

10. A binary redox flow battery, comprising:
a redox flow battery unit converting electricity to the chemical energy of electrolytes (“E-to-C unit”), comprised of
a positive compartment having an electrolyte (“positive-side-electrolyte”), a bipolar plate, and a catalyst attached directly to a surface of the bipolar plate;
a negative compartment having an electrolyte (“negative-side-electrolyte”), a bipolar plate, and a catalyst attached directly to a surface of the bipolar plate;
and an ion-permeable membrane separating said the positive and negative compartments.
a second redox flow battery unit converting the chemical energy of electrolytes to electricity (“C-to-E unit”), comprised of
a positive compartment having an electrolyte (“positive-side-electrolyte”), a bipolar plate, and a porous catalyst attached directly to a surface of the bipolar plate;
a negative compartment comprising an electrolyte (“negative-side-electrolyte”), a bipolar plate, and a porous catalyst attached directly to the surface of a bipolar plate;
and an ion-permeable membrane separating said the positive and negative compartments.
the positive-side-electrolyte contacts the positive compartments of both the E-to-C unit and the C-to-E unit, and the negative-side-electrolyte contacts the negative compartments of both the E-to-C unit and the C-to-E unit.

11. The binary redox flow battery according to claim 10, wherein the catalyst is a carbon catalyst; the positive-side-electrolyte and the negative-side electrolyte are independently selected from a group of an organic electrolyte, zinc, a zinc salt, a chromium salt, iron, an iron salt, a vanadium salt, a titanium salt, a manganese salt, a cerium salt, bromine and its analogs, chlorine and its analogs, and iodine and its analogs suspended or dissolved in an organic solution, or an aqueous acidic or basic solvent, or a mixed solvent.

12. The binary redox flow battery according to claim 11, wherein the catalyst is a porous carbon catalyst; the positive-side-electrolyte and the negative-side electrolyte are vanadium salts in an aqueous acidic solution.

13. The binary redox flow battery according to claim 11, wherein the positive-side-electrolyte and the negative-side electrolyte are iron and iron salts in an aqueous acidic solution.

14. The binary redox flow battery according to claim 11,
wherein,
the negative-side electrolyte is comprised of a titanium salt, and optionally a second electrolytic material selected from a group of an iron salt, a vanadium salt, a cerium salt, bromine and its derivatives, a water-soluble bromine complexing agent, and any combination thereof, in an aqueous acidic solution;
the positive-side-electrolyte is comprised of an electrolytic material selected from a group of an iron salt, a vanadium salt, a cerium salt, bromine and its derivatives, a water-soluble bromine complexing agent, and any combination thereof, and optionally a titanium salt, in an aqueous acidic solution;
the catalyst is a porous nitrogen-enriched carbon catalyst selected from a group of carbon or graphite felts, carbon or graphite papers, and carbon or graphite cloth, containing a nitrogen content ranging from 0.5 wt % to 50 wt %, preferably between 0.8 wt % to 30 wt %, and further preferably between 1.0 wt % and 20 wt %. Optionally, the porous nitrogen-enriched carbon catalyst is comprised of a sulfur or phosphine content ranging from 0.5 wt % to 30 wt %, preferably between 0.8 wt % and 30 wt %, further preferably between 1.0 wt % and 25 wt %, and most preferably ranging from 1.0 wt % to 20 wt %.

15. A method of producing a binary redox flow battery according to claim 10, wherein electrolyte conduits are used to transport the positive-side-electrolyte and the negative-side-electrolyte between the E-to-C unit and the C-to-E unit.

16. A method of producing a binary redox flow battery according to claim 10, wherein external electrolyte storage systems are used for storing the positive-side-electrolyte and the negative-side-electrolyte, respectively, and the stored electrolytes are transported by a transportation means selected from a group of trolleys, trains, cars, trucks, boats, and aircrafts between the E-to-C unit and the C-to-E unit.
